(19) United States
(12) Patent Application Publication
(10) Pub. No.: US 2019/0104233 A1
(43) Pub. Date: Apr. 4, 2019

(54) IMAGE FORMING APPARATUS WITH USER AUTHENTICATING FUNCTION THAT AUTHENTICATES USER LOGIN

(71) Applicant: KYOCERA Document Solutions Inc., Osaka (JP)

(72) Inventor: Toshiya MIYAI, Osaka (JP)

(73) Assignee: KYOCERA Document Solutions Inc., Osaka (JP)

(21) Appl. No.: 16/147,815

(22) Filed: Sep. 30, 2018

(30) Foreign Application Priority Data
Sep. 29, 2017 (JP) 2017-189983

(51) Int. Cl. H04N 1/44; H04N 1/00; G06F 21/36

(52) U.S. Cl. CPC H04N 1/4406; G06F 21/36; H04N 1/00411

(57) ABSTRACT

Provided is an image forming apparatus capable of achieving easy user authentication by icon selection with high security. The image forming apparatus has a user-authenticating function that authenticates login of a user. The image forming apparatus includes a login-image-registering unit and a user-authenticating unit. The login-image-registering unit registers an output image that has been outputted in the past by a user in a storage unit as a login image that is correlated with the user. The user-authenticating unit generates a login screen on which the login image of the user logging in and a plurality of dummy images are arranged in a random order, and displays the login screen on an operation unit. The user-authenticating unit, after receiving a selection operation of the login image, authenticates login of the user.

### INCORPORATION BY REFERENCE

This application is based on and claims the benefit of priority from the Japanese Patent Application No. 2017-189983 filed on Sep. 29, 2017, the contents of which are hereby incorporated by reference.

### BACKGROUND

The present disclosure relates to an image forming apparatus that includes a user authenticating function that authenticates user login.

Many image forming apparatuses such as copying machines, multifunction peripherals (MFP) and the like include a user authenticating function. A user authenticating function typically performs login according to input of a user ID and a password. In addition, allowing login by simply selecting an icon is proposed as a simple method of user authentication.

### SUMMARY

The image forming apparatus according to the present disclosure is an image forming apparatus with a user-authenticating function that authenticates login of a user. The image forming apparatus includes a login-image-registering unit and a user-authenticating unit. The login-image-registering unit registers an output image that has been outputted in the past by a user in a storage unit as a login image that is correlated with the user. The user-authenticating unit generates a login screen on which the login image of the user logging in and a plurality of dummy images are arranged in a random order, and displays the login screen on a display unit. The user-authenticating unit, after receiving a selection operation of the login image, authenticates login of the user.

### BRIEF DESCRIPTION OF THE DRAWINGS

FIG. 1 is a block diagram schematically illustrating configuration of an embodiment of an image forming apparatus according to the present disclosure.

FIG. 2 is a flowchart explaining a registration operation of the login screen illustrated in FIG. 1.

FIG. 3 is a flowchart explaining a login operation that uses the login screen illustrated in FIG. 1.

FIG. 4 illustrates an example of a login screen generated by the user-authenticating unit illustrated in FIG. 1.

### DETAILED DESCRIPTION

In the following, an embodiment according to the present disclosure will be explained in detail with reference to the drawings.

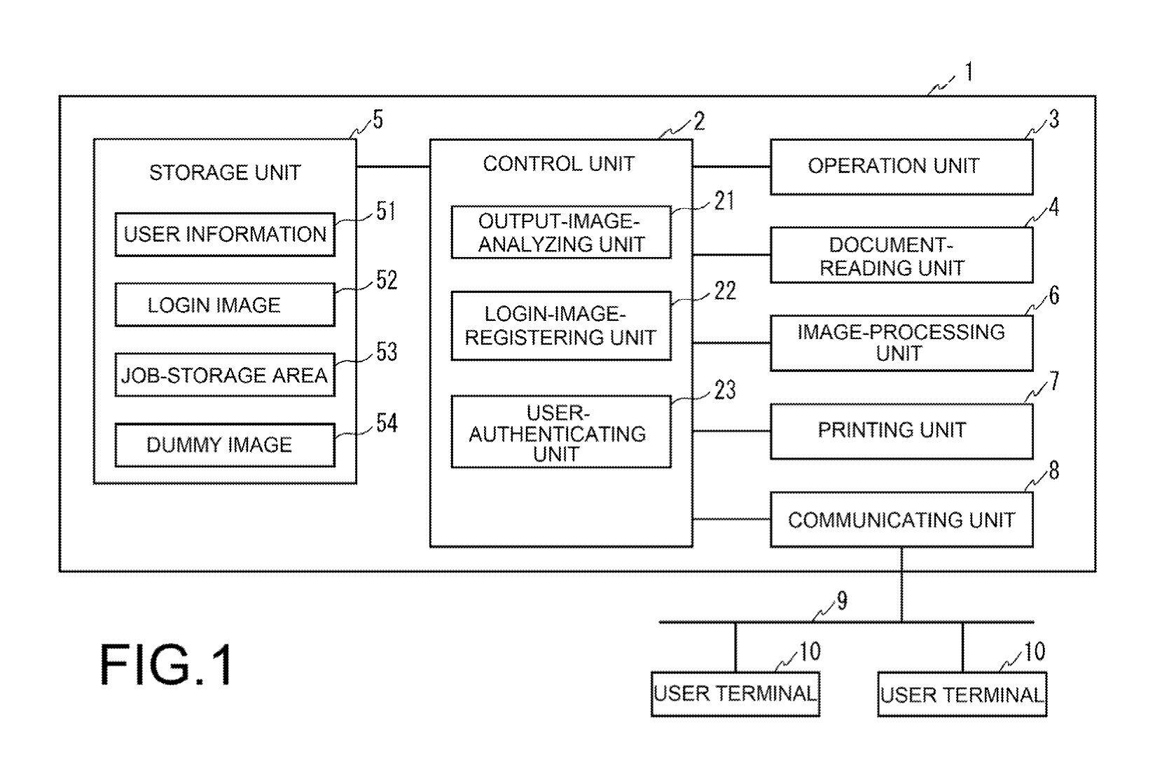

An image forming apparatus 1 of an embodiment according to the disclosure is a multifunction peripheral having a copying function, a scanner function, a facsimile function and the like. Referring to FIG. 1, the image forming apparatus 1 includes a control unit 2, an operation unit 3, a document-reading unit 4, a storage unit 5, an image-forming unit 6, a printing unit 7, and a communicating unit 8.

The control unit 2 is an information-processing unit such as a microcomputer or the like that includes a central processing unit (CPU), a read only memory (ROM), a random access memory (RAM) and the like. The ROM stores a control program for performing control of the operation of the image forming apparatus 1. The control unit 2 performs overall control of the apparatus according to instruction information by reading the control program that is stored in the ROM, and developing the control program in the RAM. In addition, the control unit 2 functions as an output-image-analyzing unit 21, a login-screen-registering unit 22 and a user-authenticating unit 23. The operation of the output-image-analyzing unit 21, the login-screen-registering unit 22 and the user-authenticating unit 23 will be described later.

The operation unit 3 is a user interface composed of a display unit that includes a touch panel provided with a transparent pressure-sensitive sensor on the surface of a liquid-crystal display panel, and various operation keys.

The document-reading unit 4 is a scanner that reads a document image by irradiating light on a document fed by a document-feeding unit or a document that is placed on a platen glass by a user, and receiving the reflected light and the like.

The storage unit 5 is a storage unit such as a semiconductor memory, hard disk drive (HDD), or the like.

The storage unit 5 stores user information 51 that is used for user authentication. The user information 51 is data correlated with user identification information such as a name, ID and the like for identifying a user, authentication information such as a password or the like, and classification information. The classification information is information that classifies a user as an administrator or a general user.

The storage unit 5 stores a login image 52 that is used for user authentication. The login image 52 is a thumbnail image of an output image that has been outputted in the past by the printing unit 7. In addition, a login image 52 is registered for each user, and is the most recent image matching specific conditions. The login image 52 is displayed together with dummy images on the operation unit 3 at the time of login, and user login is authenticated by a user correctly selecting the login image 52.

In the storage unit 5, a job-storage area 53 is set in which various jobs such as printing jobs and the like received from a user terminal 10 are stored. The job-storage area 53 is a storage area in which various jobs that are received by the communicating unit 8 are stored. The data format of a job is not particularly limited. The target data format of a job is, for example, a printing format using page description language (PDL), various image formats, document formats according to various applications, and the like. In addition, owner information is provided for a job. A job is then concealed when the login user is different than the owner.

The storage unit 5 also stores dummy images 54. Dummy images 54 are images that are displayed at login together with the login image 52.

The image-processing unit 6 is an arithmetic processing circuit such as a microcomputer or the like that includes a central processing unit (CPU), a read only memory (ROM), a random access memory (RAM) and the like. The image-processing unit 6, for example, executes various jobs related to image processing such as enlargement/reduction processing, density adjustment processing, gradation adjustment processing and the like.

The printing unit 7 is a printing unit that prints an output image that is formed based on image data read by the document-reading unit 4, a job stored in the storage unit 5, or a job received by the communication unit 8 on recording paper.

The communicating unit 8 has a function of transmitting or receiving various data to and from a user terminal 10 such as personal computer or the like via a network 9 such as an LAN or the like.

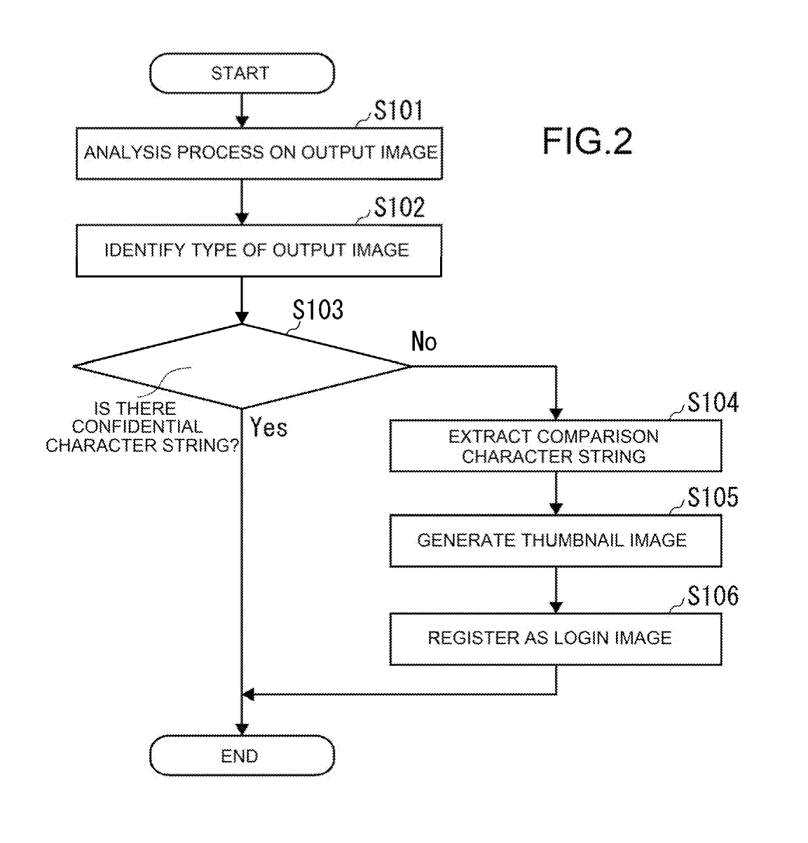

Next, the registering operation of the login image 52 will be explained in detail with reference to FIG. 2.

When printing is executed by the printing unit 7 in the login state, the control unit 2 functions as the output-image-analyzing unit 21 and executes an analysis process, including character recognition, on the output image (step S101). In this embodiment, the analysis process by the output-image-analyzing unit 21 specifies monochrome or color, specifies a character string and character-string size, and specifies the image area such as a figure, a photo, a picture and the like. Incidentally, in the case where the output image is a plurality of pages, basically the analysis process can be executed for the first page, however the user can also specify a number of pages.

Next, the output-image-analyzing unit 21 specifies the type of output image based on the analysis results (step S102). In this embodiment, the output image is classified for monochrome and color respectively as an image of only a character string, an image in which a character string is mixed with image area such as a figure, photo, picture and the like, and an image of only an image area. In other words, the output image is classified into one of a total of 6 (2×3) types.

Next, the control unit 2 functions as the login-image-registering unit 22. First, the output-image-analyzing unit 21 determines whether or not the output image includes a confidential character string (for example, company secret, classified, confidential, or the like) indicating that the document is a confidential document (step S103).

In step S103, in the case where there is a confidential character string, the login-image-registering unit 22 ends the registration operation without registering the output image as a login image 52.

In step S103, in the case where there is no confidential character string, the output-image-analyzing unit 21, together with extracting a character string having a size that is equal to or greater than a specified size as a comparison character string (step S104), generates a thumbnail image of the output image (step S105). Then, the login-image-registering unit 22 correlates the login user, the type and the comparison character string. The login-image-registering unit 22 then registers the generated thumbnail image as the login image 52 (step S106), and ends the registration operation. Incidentally, in the case where a login image 52 of the same user as the login user is registered, the image is updated and registered. Then, the most recent login image 52 that matches specific conditions is registered for each user.

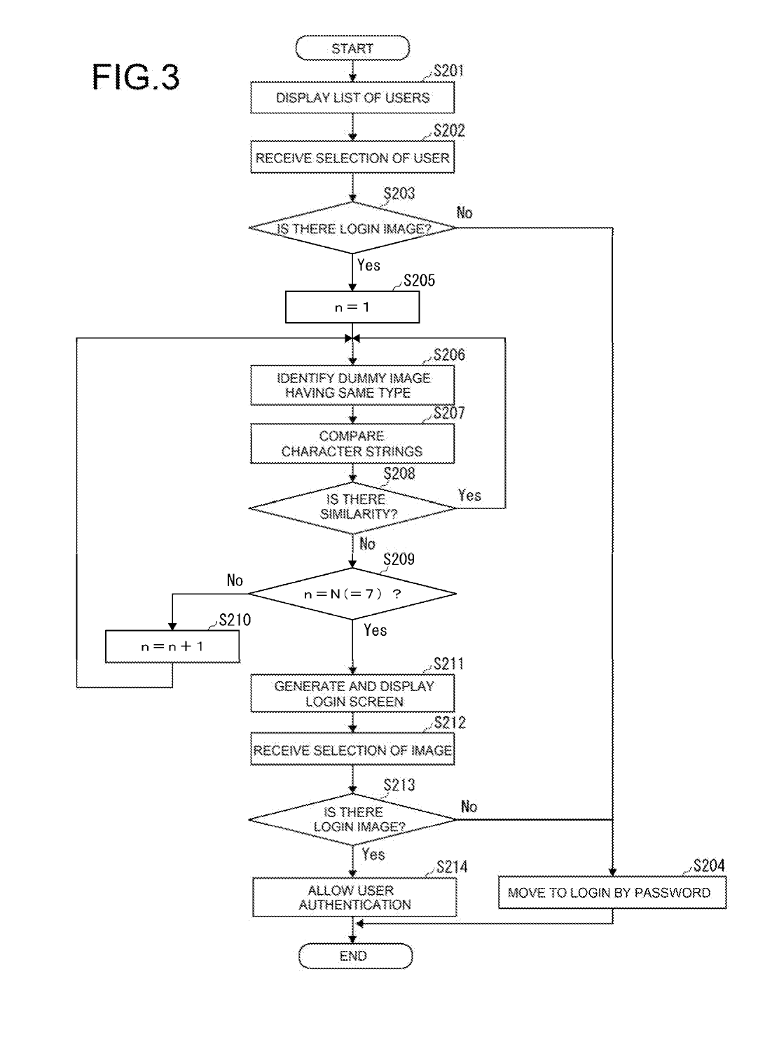

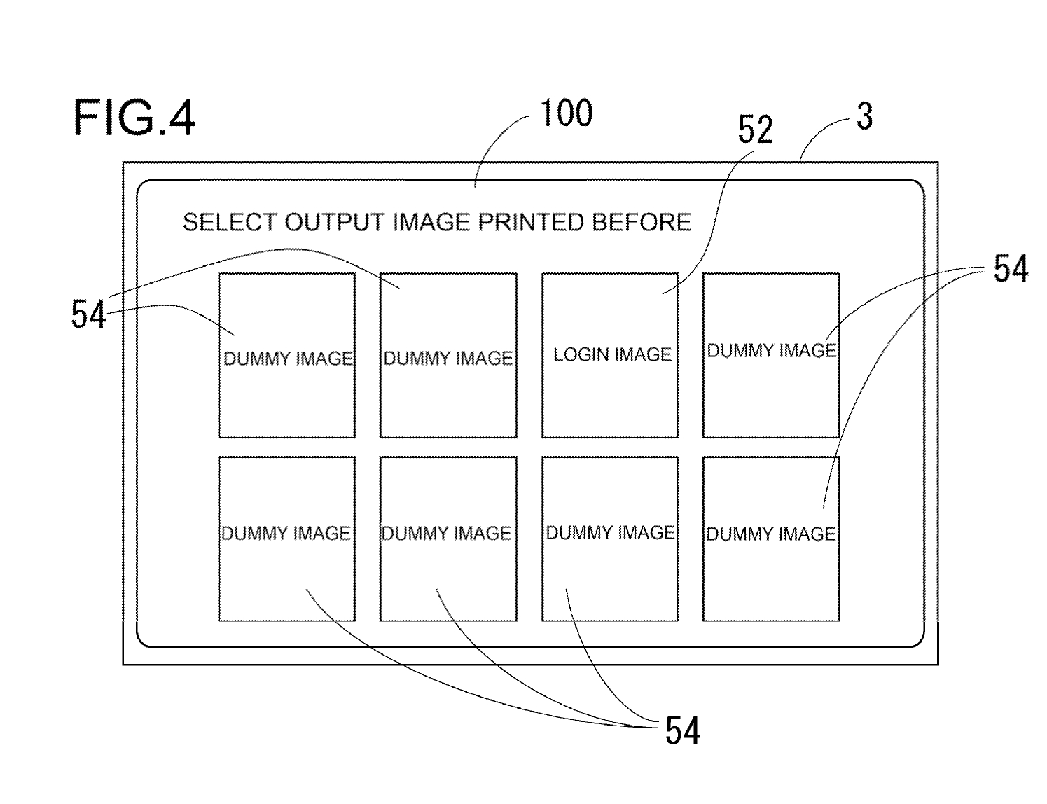

Next, a login operation that uses the login image 52 will be explained in detail with reference to FIG. 3 and FIG. 4.

First, the control unit 2 functions as the user-authenticating unit 23. The user-authenticating unit 23 displays a list of users registered in the user information 51 on the operation unit 3 (step S201). Then, the user-authenticating unit 23 receives a selection of a user (step S202).

Next, the user-authenticating unit 23 determines whether or not a login image 52 is stored in the storage unit 5 for the user for which a selection has been received (step S203).

In step S203, when a login image 52 is not stored in the storage unit 5, the user-authenticating unit 23 moves to a login operation by password (step S204), and ends the login operation that uses a login image 52.

In step S203, when a login image 52 is stored in the storage unit 5, the user-authenticating unit 23 sets a variable n to 1 (step S205), and specifies a dummy image 54 of the same type as the login image 52 (step S206). Incidentally, a suitable number of dummy images 54 are registered for each type. Then, in step S206, one dummy image 54 is specified at random.

Next, the user-authenticating unit 23 compares the comparison character string of the login image 52 with a character string of the dummy image 54 specified in step S206 (step S207), and determines whether or not there is a similarity (step S208). Determining there is a similarity can be performed, for example, by identifying each word by phrase analysis and determining the matching rate of the words. Incidentally, the character string of the dummy image 54 can be obtained by extracting a visible character string from the dummy image 54. In addition, the character string of the dummy image 54 can be a visible character string that is correlated with the dummy image 54 and stored in advance.

In step S208, in the case where there is a similarity, the user-authenticating unit 23 cancels the specification of the dummy image 54, returns to step S206 and specifies the next dummy image 54.

In step S208, when there is no similarity, the user-authenticating unit 23 determines whether or not the variable n has reached a preset specified number N (for example, N=7) (step S209).

In step S209, in the case where the variable n has not reached the specified number N, the user-authenticating unit 23 increments the variable n (step S210), then returns to step S206 and specifies the next dummy image 54.

The case where the variable n has reached the specified number N in step S209 will be explained. In this case, as illustrated in FIG. 4, the user-authenticating unit 23 generates a login screen 100 on which the login image 52 and the dummy image 54 for the specified number N are arranged in a random order, and displays the login screen 100 on the operation screen 31 (step S211). Then, the user-authenticating unit 23 receives a selection operation by the user (step S212).

Next, the user-authenticating unit 23 determines whether or not the selection operation is a login image 52 (step S213).

In step S213, in the case where the selection operation is the login image 52, the user-authenticating unit 23 authenticates the login of the user (step S214), and ends the login operation that uses a login image 52.

In step S213, in the case where the selection operation is not a login image 52, but is any of the dummy images 54, the user-authenticating unit 23 moves to step S204 to the login operation by a password, and ends the login operation using the login image 52.

Incidentally, in this embodiment, one login image 52 is stored for each user, however, a plurality of login images 52 may be stored for each user. Then, login of a user may be authenticated when a plurality of login images 52 are correctly selected and operated on the login screen 100. In addition, respective login screens 100 may be generated for each of the plurality of login images 52, and user login may be authenticated when login images 52 are correctly selected and operated on all of the login screens 100. Incidentally, when the number of login images 52 exceeds a preset number, login images 52 may be discarded starting from the oldest. Moreover, a login image 52 may be discarded when the registration period exceeds a preset period.

In addition, in the case where a plurality of login images 52 is stored for each user, the login images 52 may be correlated with a registration date and time and a set time required for output, and registered. Then, based on the registration date and time and the set time, a login image 52 having a high priority may be selected and arranged on the login screen 100. In this case, the newer the registration date and time is, the higher the possibility that a user remembers them, so the priority also becomes higher. Moreover, the longer the set time is, the higher the possibility that a user remembers them, so the priority also becomes higher.

Furthermore, settings at output (color, 2-in-1, staple, and the like) may be correlated with the login image 52 and registered. Then, when the login image 52 is correctly selected and operated on the login screen 100, the settings of the login image 52 may be reflected on the settings at login.

In addition, a login image 52 of another user may be arranged on the login screen 100 as a dummy image 54. Moreover, an image of a job of a user stored in the job-storage area 53 may be arranged on the login screen 100 as the login image 52.

As explained above, according to this embodiment, an image forming apparatus 1 includes a user-authenticating function that authenticates login of a user, and includes: a login-image-registering unit 22 that registers an output image that has been outputted in the past by a user in a storage unit 5 as a login image 52 that is correlated with the user; and a user-authenticating unit 23 that generates a login screen 100 on which a login image 52 of the user logging in and a plurality of dummy images 54 are arranged in a random order, and displays the login screen 100 on an operation unit 3; wherein the user-authenticating unit 23 authenticates login of the user after receiving the selection operation of the login image 52.

With this configuration, by setting a login image that only a user himself/herself knows as information to be used during login, login can be performed by a simple selection operation for the user, while at the same time unauthorized login due to impersonation or the like can be eliminated. Therefore, highly secure and simple user authentication by selection of an icon can be achieved.

Furthermore, in this embodiment, an output-image-analyzing unit 21 that analyzes and identifies a type of output image is provided, and the login-image-registering unit 22 registers a login image 52 that is correlated with the type identified by the output-image-analyzing unit 21 in the storage unit 5, and the user-authenticating unit 23 generates a login screen 100 that uses dummy images 54 that are of the same type as the login image 52.

With this configuration, by arranging the login image 52 among the dummy images 54 of the same type, unauthorized login due to impersonation or the like can be effectively prevented.

Furthermore, in this embodiment, the login-image-registering unit 22 registers an output image in the storage unit 5 as the login image 52 on the condition that a confidential character string that indicates that the output is a confidential document is not included in the output image.

With this configuration, it is possible to prevent a confidential document from being disclosed.

In addition, in this embodiment, the login-image-registering unit 22 updates and registers an output image in the storage unit 5 as the login image 52.

With this configuration, the most recent output image having the highest probability of remaining in the user's memory is registered as the login image 52. Therefore, the user can easily perform a selection operation of the login image 52 on the login screen 100.

Moreover, in this embodiment, the login-image-registering unit 22 correlates a character string included in the login image 52 having a specified size or larger as a comparison character string, and registers the login image 52 in the storage unit 5, and the user-authenticating unit 23 generates a login screen 100 that excludes dummy images 54 that include a character string that is similar to the comparison character string.

With this configuration, dummy images 54 that cannot be easily distinguished from the login image 52 can be excluded from the login screen 100. Therefore, the user can easily perform a selection operation of the login image 52 on the login screen 100.

Furthermore, in this embodiment, the login-image-registering unit 22 registers a plurality of login images 52, to which a registration date and time and a set time required until output are correlated, in the storage unit 5, and the user-authenticating unit 23, on the basis of the registration date and time and the set time, sets the priority of a login image 52 to be higher the newer the registration date and time is or the longer the set time is, and selects a login image 52 having high priority and arranges that login image 52 on the login screen 100.

With this configuration, it is possible to arrange a login image 52 having a high probability of remaining in the user's memory on the login screen 100.

In the typical technique described above, inputting a user ID and a password at each login is troublesome for the user. In addition, in simple user authentication by icon selection, information of the icon to be selected is easily leaked, so there is a problem of low security.

Taking into consideration the above-mentioned problems, the object of the technique according to the present disclosure is to provide an image forming apparatus capable of achieving easy user authentication by icon selection with high security.

According to the present disclosure, by setting a login image that only a user himself/herself knows as information to be used during login, login can be performed by a simple selection operation for the user, while at the same time unauthorized login due to impersonation or the like can be eliminated. Therefore, there is an advantage in that highly secure and simple user authentication by selection of an icon can be achieved.

Note that, the technology according to the present disclosure is not limited to each of the embodiments described above, and it is clearly understood that each of the embodiments may be appropriately modified within the scope of the technical idea of the present disclosure. Moreover, the number, position, shape and the like of the components described above are not limited to those in the embodiments described above, and a number, position, shape and the like suitable for embodying the technology according to the present disclosure may be used. Incidentally, in each of the drawings, the same reference numbers are used for components that are the same.

What is claimed is:

1. An image forming apparatus with a user-authenticating function that authenticates login of a user, the image forming apparatus comprising:
a login-image-registering unit that registers an output image that has been outputted in the past by a user in a storage unit as a login image that is correlated with the user; and
a user-authenticating unit that generates a login screen on which the login image of the user logging in and a plurality of dummy images are arranged in a random order, and displays the login screen on a display unit; wherein
the user-authenticating unit, after receiving a selection operation of the login image, authenticates login of the user.

2. The image forming apparatus according to claim 1 further comprising an output-image-analyzing unit that analyzes and identifies a type of the output image; wherein
the login-image-registering unit correlates the type identified by the output-image-analyzing unit with the login image and registers the login image in the storage unit; and
the user-authenticating unit generates the login screen using the dummy images of the same type as the login image.

3. The image forming apparatus according to claim 1, wherein
the login-image-registering unit registers an output image in the storage unit as the login image on the condition that a confidential character string to indicate a confidential document is not included in the output image.

4. The image forming apparatus according to claim 1, wherein
the login-image-registering unit updates and registers the output image in the storage unit as the login image.

5. The image forming apparatus according to claim 1, wherein
the login-image-registering unit correlates a character string included in the login image having a specified size or larger as a comparison character string, and registers the login image in the storage unit; and
the user-authenticating unit generates the login screen that excludes the dummy images that include a character string that is similar to the comparison character string.

6. The image forming apparatus according to claim 1, wherein
the login-image-registering unit registers a plurality of login images, to which a registration date and time and a set time required until output are correlated, in the storage unit; and
the user-authenticating unit, on the basis of the registration date and time and the set time, sets a priority of a login image to be higher the newer the registration time is or the longer the set time is, and selects a login image having high priority and arranges that login image on the login screen.
